(19) United States
(12) Patent Application Publication
(10) Pub. No.: US 2020/0296803 A1
(43) Pub. Date: Sep. 17, 2020

(54) HEATING DEVICE

(71) Applicant: Robert Bosch GmbH, Stuttgart (DE)

(72) Inventor: Jan Ruigrok Van De Werve, Stuttgart (DE)

(21) Appl. No.: 16/649,253

(22) PCT Filed: Jul. 24, 2018
(86) PCT No.: PCT/EP2018/069998

§ 371 Date: Mar. 20, 2020

(30) Foreign Application Priority Data
Sep. 21, 2017 (DE) 10 2017 216 723.8

(51) Int. Cl. H05B 3/14; H05B 3/82

(52) U.S. Cl. CPC H05B 3/146; F01N 3/2066; H05B 3/82

(57) ABSTRACT

The invention relates to a heating device for heating a liquid, in particular a liquid in a tank for storing the liquid, having at least one heating element and at least one thermally conductive body, characterized in that the heating element consists of an electrically conductive plastics material, and in that the electrically conductive plastics material is coupled to the thermally conductive body in an electrically and thermally conductive manner.

### BACKGROUND OF THE INVENTION

The invention is based on a heating device, a tank installation unit and a method for producing a heating device.

Heating devices comprising heating elements and heat distribution bodies are already known, for example, from DE102011084962, but the heating elements in said heating devices are designed as prefabricated or piecemeal PTC heating elements with which contact can be made via busbars. In this case, a thermally conductive body which is coupled to the heating elements is encapsulated by injection molding with a plastics layer.

Tank installation units comprising heating devices of this kind, which tank installation units can also have or be fitted with a conveyor pump, a sensor system, e.g. a filling level sensor system, and a filter device for example in addition to said heating devices, are known from DE102015200168. Tank installation units of this kind can be flange-connected to the opening of a tank, for example in the base region of the tank, or can be arranged in the region of the opening and welded to the tank wall. Arrangements of this kind allow only a specific diameter of the tank installation unit which has an installation space-limiting effect on all of the structural parts located on the carrier of the tank installation unit.

### SUMMARY OF THE INVENTION

The heating device and the tank installation unit according to the invention and the production method according to the invention have the advantage over the above prior art of a simplified construction and the ability to provide improved functioning. There is no need for any undefined calking or grouting processes, fragile insulation ceramics, prefabricated PTC elements or separate busbars.

### BRIEF DESCRIPTION OF THE DRAWINGS

Exemplary embodiments of the invention are illustrated in the drawing and explained in more detail in the following description.

In the drawing,

FIG. 1 shows a heating device,

FIG. 2 shows a ram contact, and

FIG. 3 shows a tank installation unit.

### DETAILED DESCRIPTION

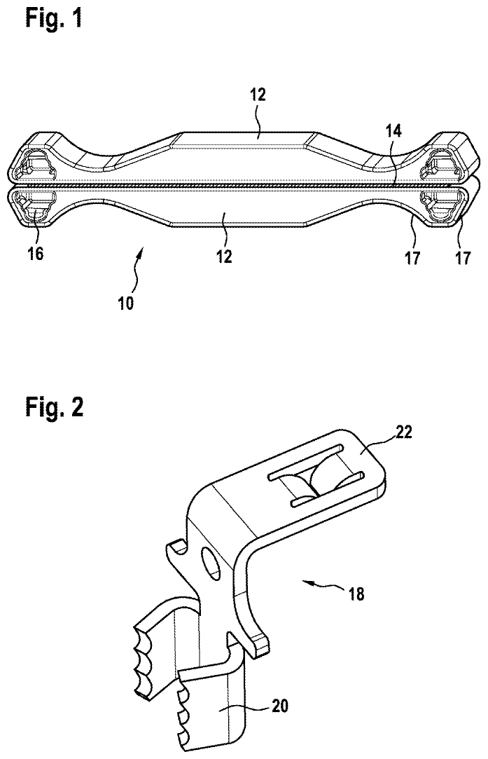

FIG. 1 illustrates a perspective view of a heating device 10. Said heating device comprises a sheet-like heating element 14 which is elongate in the present exemplary embodiment and is arranged between two thermally conductive bodies 12. The thermally conductive bodies 12 are manufactured, for example, from aluminum. The thermally conductive bodies are preferably symmetrical identical parts, as depicted. At their ends along their longitudinal extent, said thermally conductive bodies have recesses 16 which serve to position and, respectively, to lock the heating device on a base plate or the like, for example by way of a snap-action/clamping connection.

The heating element 14 is manufactured from a heatable, i.e. electrically conductive plastic. Said plastic may be, for example, high-density polyethylene (“HDPE”) to which graphite containing a mass fraction, in particular, of 30 to 45 percent of the total mass of the heating element has been added. Here, the two thermally conductive bodies 12 are adhesively bonded to one another by means of this electrically conductive plastics material. If HDPE containing said graphite admixture is used, the heating element exhibits a self-regulating behavior, that is to say, with an electrical voltage applied between the two thermally conductive bodies, the electrical resistance significantly increases when the temperature rises or when it exceeds a certain threshold value. The thermal dissipation to a liquid environment is optimized with the two thermally conductive bodies which are of simple construction and composed of aluminum. Said thermally conductive bodies give off heat which is created between them in an effective manner and over a large surface area.

For permanent connection of these thermally conductive aluminum bodies, they are correspondingly pretreated on the contact side which faces the heating element 14 in the finished state of the heating device. To this end, a rough surface (mean roughness depth Rz 36 . . . 100) is provided, preferably by means of plasma treatment. The thermally conductive aluminum bodies are then clamped in a mold. The contact layer or the material which then forms the heating element 14 is then injected. The thermally conductive aluminum bodies are then fixedly connected to one another. In a further step, they are placed into a different mold and suitably positioned, so that they can be encapsulated by injection molding all the way around with (non-electrically conductive) high-density polyethylene for the purpose of corrosion protection.

In a preferred variant of the production method, electrical contacts, in particular in the form of ram contacts, are initially pressed in after said process of encapsulation by injection molding. As a result, the production method is simplified. This facilitates the sealing of the contact region in the mold for encapsulation by injection molding.

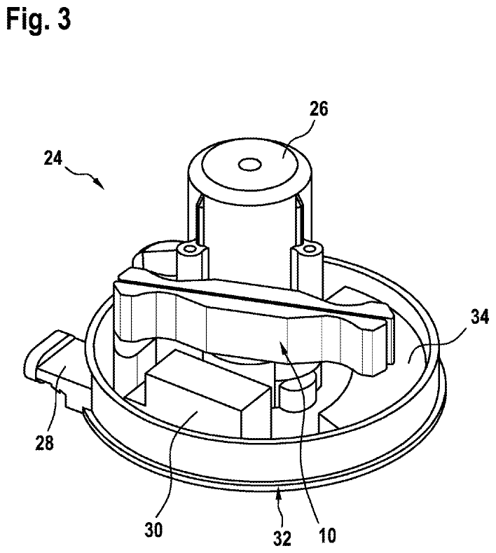

FIG. 2 shows, by way of example, a ram contact 18 of this kind which has a twin-wing ram terminal 20 at one end and a connection region 22 at the other bent-away end. Here, the two wings of the ram terminal 20 can be rammed or pressed into the region of the two flanks 17 (see FIG. 1) of a thermally conductive body 12 which are each adjacent to a recess 16. This is done on in each case at least one pair 17 of flanks of this kind for each thermally conductive body, in order to be able to excite an electric current flow, which generates ohmic heat, across the thermally conductive bodies through the heating element 14 in the case of heat requirement.

The finished heating device 10 can become, for example, a constituent part of a tank installation unit, wherein the heating device 10, in the region of its recesses 16, can be welded to a base region of the tank installation unit.

A tank installation unit 24 of this kind especially for being fitted in a base region of a liquid tank is illustrated in FIG. 3. The fluid-tight connection of the tank installation unit 24 to the liquid tank is made at the edge of a base region 32 of the tank installation unit, for example by welding to the tank base. The base region or carrier 32 is fitted with various functional components, a conveyor pump 26, a filling level sensor system 30 and a filter device 34 being illustrated by way of example. Further examples include electrical and/or hydraulic connections for electrically actuating functional components or for transporting away the liquid which is stored in the tank. The heating device 10 is then positioned at a suitable location in order to be able to readily heat temperature-critical locations, in particular in order to keep warm or to thaw regions at risk of freezing to a sufficient extent in order to ensure continuous transportation of liquid out of the tank using the conveyor pump.

The heating device is suitable, in particular, for tank installation units for storage containers which can be filled with an aqueous urea solution in order to provide this reducing agent for selective catalytic reduction of nitrogen oxides of an internal combustion engine of a motor car. The heating device can also be used for heating or thawing other liquids, and can also be provided for other purposes in the field of heating, in particular, liquids.

1. A heating device (10) for heating a liquid, the heating device comprising at least one heating element (14) and at least one thermally conductive body (12), characterized in that the heating element (14) is made of an electrically conductive plastics material, and in that the electrically conductive plastics material is electrically conductively and thermally conductively coupled to the at least one thermally conductive body (12).

2. The heating device (10) as claimed in claim 1, characterized in that the electrically conductive plastics material is in direct mechanical contact with the at least one thermally conductive body (12).

3. The heating device (10) as claimed in claim 1, characterized in that the electrically conductive plastics material contains a plastics component and an electrically conductive component.

4. The heating device (10) as claimed in claim 3, characterized in that the plastics component contains polyethylene.

5. The heating device (10) as claimed in claim 3, characterized in that the electrically conductive component is graphite.

6. The heating device (10) as claimed in claim 5, characterized in that approximately 30 to 45 percent of the total mass of the plastics material consists of graphite.

7. The heating device (10) as claimed in claim 1, characterized in that the heating element (14) is arranged in a sheet-like manner between the at least one thermally conductive body (12) and a second thermally conductive body (12).

8. The heating device (10) as claimed in claim 7, characterized in that the heating element (14) connects the at least one thermally conductive body (12) and the second thermally conductive body (12) to one another in a mechanically fixed manner.

9. The heating device (10) as claimed in claim 7, characterized in that a respective contact element (18) is attached to each of the at least one thermally conductive body (12) and the second thermally conductive body (12).

10. The heating device (10) as claimed in claim 9, characterized in that the respective contact elements are ram contacts.

11. The heating device (10) as claimed in claim 1, characterized in that the heating element (14) and the thermally conductive body (12) are encased with a plastics layer.

12. A tank installation unit (24) comprising a heating device (10) as claimed claim 1.

13. A method for producing a heating device for heating a liquid, the device comprising at least one thermally conductive body (12) and at least one heating element (14), the method comprising using an electrically conductive plastics material for the heating element, and electrically conductively and thermally conductively coupling the electrically conductive plastics material to the thermally conductive body (12).

14. The heating device (10) as claimed in claim 1, wherein the heating device (10) is configured for heating a liquid in a tank for storing the liquid.

15. The heating device (10) as claimed in claim 1, wherein the thermally conductive body (12) is manufactured from aluminum.

16. The heating device (10) as claimed in claim 3, characterized in that the plastics component contains high-density polyethylene (“HDPE”), polyamide and/or polyacrylamide.

17. The heating device (10) as claimed in claim 3, characterized in that the plastics component contains high-density polyethylene.

18. The heating device (10) as claimed in claim 1, characterized in that the heating element (14) and the thermally conductive body (12) are encapsulated by injection molding with plastic.

19. A tank installation unit (24) configured for installation into a base region of a tank for storing liquid, the tank installation unit comprising a heating device (10) as claimed claim 1.

20. The method as claimed in claim 13, further comprising using the heating device for heating the liquid in a tank for storing the liquid.
